(19) United States
(12) Patent Application Publication
(10) Pub. No.: US 2009/0274133 A1
(43) Pub. Date: Nov. 5, 2009

(54) COMMUNICATION APPARATUS, CONTROL METHOD, AND STORAGE MEDIUM THEREOF

(75) Inventor: Kazunari Watanabe, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/419,164

(22) Filed: Apr. 6, 2009

(30) Foreign Application Priority Data
Apr. 30, 2008 (JP) 2008-119056

(51) Int. Cl. H04W 84/12; H04L 27/28

(52) U.S. Cl. 370/338; 375/260

(57) ABSTRACT

A communication apparatus that can perform communication with an external apparatus by switching between a plurality of communication methods, the communication apparatus comprises: a detection unit that detects a change in a position and/or orientation of the communication apparatus; and a switching unit that switches a communication method for use in accordance with a detection result by the detection unit.

### BACKGROUND OF THE INVENTION

1. Field of the Invention

The present invention relates to a communication apparatus, a control method, and storage medium thereof. In particular, as for a communication apparatus that performs wireless transmission under the MIMO transmission method, the invention relates to technology for automatically selecting a communication method that suits a state in which the communication apparatus is used.

2. Description of the Related Art

While a wireless transmission path is used as a data transfer transmission path, a wireless LAN is widely known as a general wireless transmission path. Also, a broad-band wireless transmission method in which the MIMO (multi-input multi-output) transmission method is applied has been considered as technology for realizing transmission of a large amount of data. The MIMO transmission method is also applied in IEEE 802.11n, which is a standard for wireless LANs. The MIMO transmission method is technology for realizing increase in the capacity of transmission by providing a plurality of antenna elements to a transmitter side and a recipient side, and forming a plurality of logical space streams using space-division multiplexing, without increasing the frequency bandwidth to be used.

Meanwhile, the STBC (space-time block coding) transmission method is known as technology for improving transmission reliability under a wireless transmission method, and is also applied in IEEE 802.11n, described above. There is a case in which wireless transmission is performed under the STBC transmission method using two antenna elements on the transmitter side. The principle of such a case is described below.

Assume that data s0, s1 is transmitted at time t from the antenna elements on the transmitter side. After that, the transmitter transmits data −s1*, s0* (* is a complex conjugate) at time t+T. In this case, the recipient receives the aforementioned data (s0, s3 and −s1*, s0*) and detects the data using linear computation. Accordingly, the recipient can obtain as much diversity gain as that obtained using maximum ratio combining. The STBC transmission method is technology for improving transmission reliability using the above principle.

As technology employing the aforementioned STBC transmission method, a wireless transceiver disclosed in Japanese Patent Laid-Open No. 2006-333283 (hereinafter, Patent Document 1) is known. In the MIMO wireless transceiver, priority control for determining priority of transmission data, and a transmission mode table are provided. Further, when transmitting, the choice of whether or not to use the STBC transmission method is performed, or an encoding ratio and a modulation method are controlled, based on the transmission mode with respect to a destination determined in accordance with the priority of the transmission data and the state of the transmission path.

With a configuration as disclosed in Patent Document 1, “the priority of transmission data” is classified into four categories so as to be set in each category in accordance with a transmission data type. Also, determination of “the state of the transmission path” is performed according to which of an ACK frame and a NACK frame transmitted from the recipient was received.

With the configuration disclosed in Patent Document 1, in case where the determined priority of the transmission data is high, wireless transmission is controlled and performed using the STBC transmission method. Consequently, this reduces the number of re-transmissions and realizes a reduction in transmission delay time. As a result, throughput is increased.

With the configuration disclosed in Patent Document 1, the transmission method used is selected based on the transmission data priority. After that, if the state of the transmission path changes, selection of a transmission method is repeated. Then, the aforementioned “state of the transmission path” is determined according to which of the ACK frame and the NACK frame transmitted from the recipient was received.

However, if changes in “the state of the transmission path” are determined by using such a method, it takes time to analyze which of the ACK frame and the NACK frame was received. Further, if transmission data was transmitted between when the change in “the state of the transmission path” occurs and when the transmission method is changed, a procedure, such as re-transmission of the transmission data, will be performed. Thus, it cannot be said that such transmission method change is efficiently controlled in accordance with the change in “the state of the transmission path”.

Moreover, in the case of forming a wireless transmission path using the MIMO transmission method, significant influence is exerted on the transmission rate due to changes in the wireless transmission path. This is caused by changes in transmission characteristics, such as those of a wireless transmission path in a multipath environment if the orientation of the apparatus performing the wireless communication itself is changed or the apparatus is moved. That is, if the transmission characteristics change, it becomes difficult to maintain a plurality of space streams formed under the MIMO transmission method along the wireless transmission path. Thus, a transmission error or retransmission due to the transmission error occurs. Accordingly, the transmission rate becomes extremely low.

Therefore, under wireless transmission using the MIMO transmission method as described above, when transmission data is transmitted between when a change in “the state of the transmission path” occurs and when the transmission method is changed, data itself may possibly disappear. In addition, the STBC transmission method can improve transmission reliability; however, the transmission rate becomes low, because data is transmitted a plurality of times.

### SUMMARY OF THE INVENTION

The present invention was achieved in view of the above problems. The present invention provides technology that enables appropriate switching between communication in which reliability is given priority and communication in which a transmission rate is given priority in accordance with the circumstances of such communication.

According to one aspect of the present invention, a communication apparatus that can perform communication with an external apparatus by switching between a plurality of communication methods, the communication apparatus includes: a detection unit that detects a change in a position and/or orientation of the communication apparatus; and a switching unit that switches a communication method for use in accordance with a detection result by the detection unit.

According to another aspect of the present invention, a method for controlling a communication apparatus that can perform communication with an external apparatus by switching a plurality of communication methods, the method comprises the steps of: detecting a change in a position and/or orientation of the communication apparatus; and switching a communication method for use in accordance with a detection result in the detecting step.

Further features of the present invention will become apparent from the following description of exemplary embodiments with reference to the attached drawings.

### BRIEF DESCRIPTION OF THE DRAWINGS

FIG. 1 is a diagram showing a configuration of a wireless communication system.

FIG. 2 is a block diagram showing a configuration of a wireless communication unit.

FIG. 3 is a flow chart showing the flow of transmission control processing performed by a digital camera.

FIG. 4 is a flow chart showing the flow of transmission control processing performed by a digital camera.

### DESCRIPTION OF THE EMBODIMENTS

Hereinafter, exemplary embodiments according to the present invention will be described in detail with reference to the attached drawings. However, it should be noted that the constituent elements described in these embodiments are merely exemplary, and are not intended to limit the scope of the present invention. It should also be noted that all the combinations of the features described in the embodiments are not necessary to solve the problems of the present invention.

One exemplary embodiment (first embodiment) of the present invention will be described with reference to the drawings. In the present exemplary embodiment, the IEEE 802.11 standard and various types of related standards including IEEE 802.11n, which is an extension of the IEEE 802.11 standard, are used in wireless communication. However, the present invention is also applicable to the use of a communication method in accordance with another communication standard in addition to the use of communication standards such as the IEEE 802.11 standard or IEEE 802.11n.

System Configuration

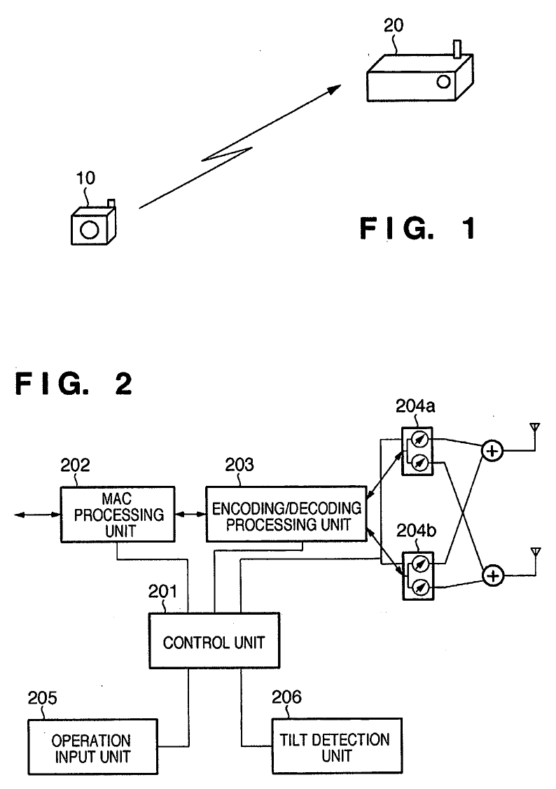

FIG. 1 is a diagram showing one typical example of a wireless communication system for performing transmission control of wireless transmission according to the present exemplary embodiment. The wireless communication system includes an STA (station) as a wireless terminal and an AP (access point) as a base station. Although a system including one STA and one AP is exemplified herein so as to allow the system to be easily understood, another system configuration including the STA and the AP may also be applied. For example, the system may include a plurality of STAs and APs.

Reference numeral 10 denotes an STA having a function of transmitting video data. Here, the STA 10 is realized by a digital camera that transmits image data using a wireless LAN communication function.

Reference numeral 20 denotes an AP having a function of receiving video data and an access point function in a wireless LAN. Also, the AP 20 also has a function as a server device that receives and stores image data using the wireless LAN communication function.

If the STA 10 establishes logical association with the AP 20, a network (BSS: basic service set) constituted from the AP 20 and the STA 10, which is under the control of the AP 20, is formed. Then, the STA 10 transmits the image data obtained by the digital camera to the server device (here, the AP 20) that stores the image data.

The basic operation of the server device is defined by a series of operations of storing the image data (AP 20). Hereinafter, control of wireless transmission according to the present exemplary embodiment will be described by specifically describing the basic operation.

Configuration of Wireless Communication Unit

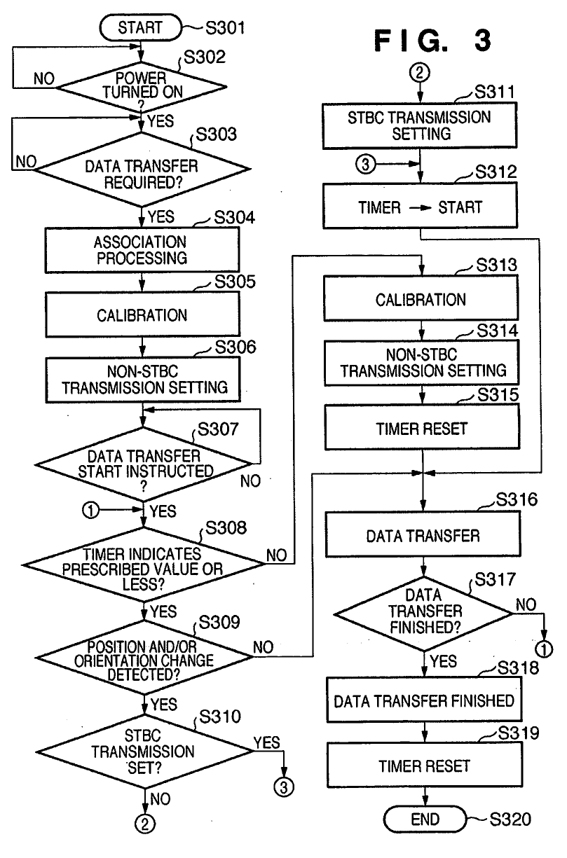

Next, a schematic configuration of a wireless communication unit for performing wireless transmission under the MIMO transmission method and the STBC transmission method (space-time block coding method) will be described. Note that, when not using the STBC transmission method, since the number of data transmissions is low, communication can be performed with the transmission rate being given priority. FIG. 2 is a block diagram showing a configuration of wireless communication unit that the STA 10 and the AP 20 respectively have, which are included in the wireless communication system shown in FIG. 1. However, as described later, an operation input unit 205 and a tilt detection unit 206 are provided to the STA 10 (digital camera) in the present exemplary embodiment.

Reference numeral 201 denotes a control unit and has a function of performing overall control of the wireless communication unit. In order to use the MIMO transmission method, the control unit 201 also generates a control signal for calibration processing, calculates a characteristic vector for setting a plurality of characteristic paths, and the like. A timer function is also provided inside the control unit 201, and a timer value can be arbitrarily set. The control unit 201 also controls the timer so as to reset, start and stop the timer at an arbitrary timing.

Reference numeral 202 denotes a MAC processing unit and a functional block that processes a MAC (medium access control) layer as shown in a wireless LAN standard (IEEE 802.11). A MAC frame is composed inside the MAC processing unit 202, and transmitted or received to/from an encoding/decoding processing unit 203. The data portion of a video stream and the like is stored in a frame body of the MAC frame. Also, various types of information (calibration information, setting information, address information, authentication information, sequence control information etc.) regarding the wireless transmission path are also stored inside the MAC frame.

The MAC processing unit 202 performs such processing with respect to a MAC frame whose type is used in a standard related to IEEE 802.11. The MAC processing unit 202 also handles MAC frames in legacy mode, mixed mode, and greenfield mode, which are specified in IEEE 802.11n, in particular.

Reference numeral 203 denotes the encoding/decoding processing unit. The encoding/decoding processing unit 203 has a function of generating a plurality of streams by dividing a MAC frame to be transmitted into a plurality of portions, or regenerating a MAC frame from a received plurality of streams.

When transmitting, a MAC frame input from the MAC processing unit 202 is divided into a plurality of streams, and the streams are transmitted to antenna weight processing units (204a and 204b). When transmitting using the MIMO transmission method, the number of characteristic paths of a wireless transmission path is predetermined by performing calibration processing and the like. Accordingly, an instruction is given from the control unit 201 to the encoding/decoding processing unit 203 so as to divide the MAC frame into the determined number of the characteristic paths.

On the other hand, when receiving, a MAC frame is regenerated from a plurality of streams transmitted from the antenna weight processing units (204a and 204b), and transmitted to the MAC processing unit 202. In this case, the number of characteristic paths of a wireless transmission path is also predetermined by performing calibration processing and the like. Thus, the encoding/decoding processing unit 203 receives streams in accordance only with the predetermined number of characteristic paths from the antenna weight processing units (204a and 204b), regenerates the MAC frame, and transmits the MAC frame to the MAC processing unit 202.

When performing transmission using the STBC transmission method, the encoding/decoding processing unit 203 generates data −s1*, s0* (* is a complex conjugate) from the generated plurality of streams (s0, s1) described above. Then, the encoding/decoding processing unit 203 performs time-division so as to transmit the data s0, −s1 and −s1*, s0*, for example, at times t and t+T to the antenna weight processing units (204a and 204b).

On the other hand, when receiving, the encoding/decoding processing unit 203 detects the aforementioned data (s0, s1 and −s1*, s0*) that was received in a time-division manner by performing linear computation, regenerates the MAC frame, and transmits the MAC frame to the MAC processing unit 202.

Reference numerals 204a and 204b denote the antenna weight processing units, and have the following functions.
A function of performing weight processing for each of a plurality of streams and transmitting the streams to antennas.
A function of performing prescribed weight processing for received signals received by the antennas, generating a plurality of streams, and transmitting the streams to the encoding/decoding processing unit 203.

The aforementioned weight processing is for varying the time information and magnitude (amplitude). The weight processing is performed based on the characteristic vector calculated by performing calibration processing and the like.

Further, the antenna weight processing units 204a and 204b also include a function of detecting the intensity of received signals received by the antennas. The antenna weight processing units 204a and 204b notify the control unit 201 of the intensity of the received signal at an arbitrary timing in accordance with an instruction from the control unit 201.

Reference numeral 205 denotes the operation input unit and a functional block provided to the digital camera (STA 10) that transmits image data. The operation input unit 205 has a function of detecting an input operation on the digital camera by an operator, and notifying the control unit (201) of the detection result. The digital camera, such as the STA 10 in the wireless communication system as shown in FIG. 1, has an operation input unit composed of an operation button. Also, the digital camera (STA 10) has a function of detecting the pressing of the prescribed button by the operator, and notifying the control unit (201) of the detection result.

Reference numeral 206 denotes the tilt detection unit and a functional block provided to the digital camera (STA 10) that transmits image data. The tilt detection unit 206 has a function of detecting a change in the orientation of the digital camera (STA 10) due to the device being moved or the like. Further, the tilt detection unit 206 also has a function of notifying the control unit (201) in accordance with such detection of the orientation of the device being changed (the device being moved).

For example, if the operator picks up the digital camera (STA 10) from a desk by hand, the tilt detection unit 206 detects the orientation of the digital camera (STA 10) having been changed, and notifies the control unit 201. Or, if the digital camera (STA 10) that is placed on a desk in a vertical direction is moved by an operation by the operator in a horizontal direction at more than a certain angle or the like so that the orientation is changed, the tilt detection unit 206 detects the orientation change and notifies the control unit 201. As described above, the tilt detection unit 206 has a function of detecting when the orientation of the digital camera (STA 10) is changed through certain angles, is moved with a certain acceleration, or the like.

Transmission Control

Next, in the wireless communication system as shown in FIG. 1, when performing wireless communication in which the MIMO transmission method for realizing fast transfer is applied, transmission control based on whether to start the STBC transmission method to improve transmission reliability will be described below with reference to an operational flow. Note that, when the STBC transmission method is not used, fast data transfer can be performed.

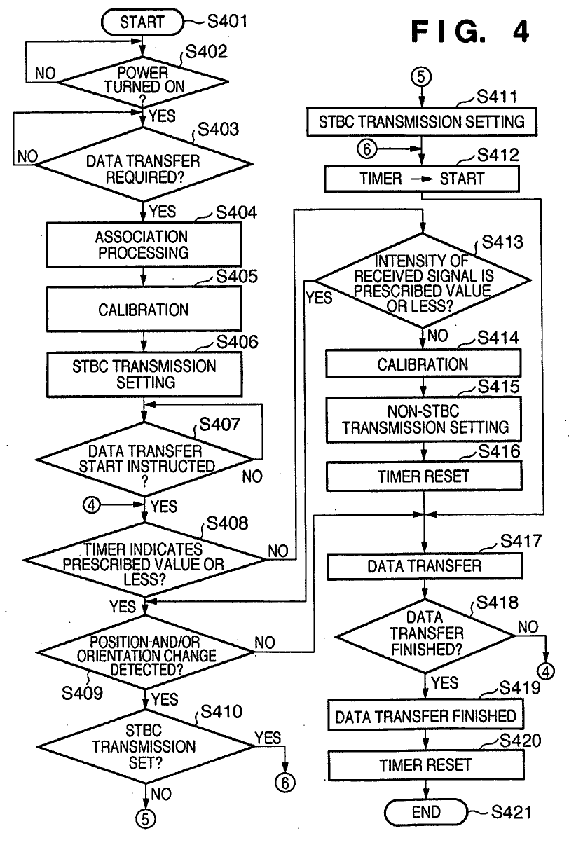

FIG. 3 is a flow chart showing the flow of transmission control processing performed by the digital camera (STA 10) when the digital camera starts up within a wireless area of the server device (AP 20). Here, it is assumed that wireless transmission is set up so as to be performed in fast mode when image data is transmitted from the digital camera to the server device (AP 20). Hereinafter, the steps will be described.
S301 (Terminal Step)

The terminal step indicates the start of the flow chart. This state indicates that the power of the digital camera is OFF, and corresponds to a state before association processing between the digital camera and the server device is performed.
S302 (Condition Determination Step)

In this condition determination step, path selection is performed based on the condition of whether or not the power of the digital camera is turned ON. If the power of the digital camera is turned ON (YES in step S302), processing proceeds to a condition determination step S303. If not (NO in step S302), the present state is maintained.
S303 (Condition determination step)

In this condition determination step, path selection is performed based on the condition of whether or not an operation to start processing for the transmission of the image data from the digital camera to the server device has been performed. If processing for transmitting the image data starts due to the digital camera being operated by the operator (YES in step S303), processing proceeds to a processing step S304. If not (NO in step S303), the present state is maintained.
S304 (Processing Step)

In this processing step, a procedure is performed so that the digital camera can connect wirelessly to the server device. Such processing is performed in accordance with a prescribed procedure specified in a standard related to IEEE 802.11 or a prescribed procedure specified in another communication protocol. Specifically, an association request frame and a response frame are exchanged, and parameter exchange and the like are performed.
S305 (Processing Step)

In this processing step, calibration is performed for wireless communication under the MIMO transmission method. Such calibration processing is performed so as to calculate a parameter used when a plurality of streams are formed under the MINO transmission method. A procedure used at this time is performed in accordance with a prescribed procedure specified in IEEE 802.11n.
S306 (Processing Step)

In this processing step, a wireless transmission path not under the STBC transmission method, but under only the MIMO transmission method is set. In accordance with the result in the processing step S305, when the image data is transmitted from the digital camera to the server device, although setting processing for wireless communication using the MIMO transmission method is performed, setting processing for wireless communication using the STBC transmission method is not performed. At this time, the timer provided in the control unit 201 is set to an initial value (reset state, e.g., 0), and the timer itself is not started up (not operating).

Note that, the timer is used for measuring elapsed time from when communication using the STBC transmission method starts between the digital camera and the server device. As described later, with the configuration according to the present exemplary embodiment, in accordance with the detection of a change in the orientation and acceleration of the digital camera, an STBC transfer setting is performed. After a certain period of time elapses after the STBC transfer setting is performed, the STBC transfer setting is cancelled.
S307 (Condition Determination Step)

In this condition determination step, path selection is performed based on the condition of whether or not an operation to start transferring the image data from the digital camera to the server device has been performed. When the operator operates the digital camera so as to start transferring the image data, the operation input unit 205 detects this operation and notifies the control unit 201 of the operation. If the control unit 201 receives the notification (YES in step S307), processing proceeds to a condition determination step S308. If not (NO in step S307), the present state is maintained.
S308 (Condition Determination Step)

In this condition determination step, path selection is performed based on the condition of whether or not the timer provided in the control unit 201 indicates a prescribed value or less. If the timer indicates the initial value (reset state), or less than or equal to the prescribed value (YES in step S308), processing proceeds to a condition determination step S309. If not (NO in step S308), processing proceeds to a processing step S313. That is, if the elapsed time from when the STBC transfer setting was performed has not exceeded the prescribed value (YES in step S30), processing proceeds to step S309. If the prescribed value is exceeded (No in step S308), processing proceeds to step S313.
S309 (Condition Determination Step)

In this condition determination step, path selection is performed based on the condition of whether or not the position and/or orientation of the digital camera has been changed due to a change in orientation (the device being moved) and the like. Specifically, when the tilt detection unit 206 detects the orientation of the digital camera being changed through certain angles, and/or the digital camera being moved with a certain acceleration, the position and/or orientation of the digital camera is determined to have been changed. If it is determined that the position and/or orientation has been changed (YES in step S309), processing proceeds to a condition determination step S310. If not (NO in step S309), processing proceeds to a processing step S316.
S310 (Condition Determination Step)

In this condition determination step, path selection is performed based on the condition of whether or not the STBC transmission method is used for a wireless transmission path between the digital camera and the server device. If a wireless transmission path has been formed for the STBC transmission method (YES in step S310), processing proceeds to a processing step S312. If not (NO in step S310), processing proceeds to a processing step S311.
S311 (Processing Step)

In this processing step, a wireless transmission path for the STBC transmission method is set between the digital camera and the server device. In the encoding/decoding processing unit 203, after a plurality of streams is generated, data −s1*, s0* (* is a complex conjugate) is generated from the streams (s0, s1). Then, time-division is performed so as to transmit the data s0, s1 and −s1*, s0*, for example, at times t and t+T to the antenna weight processing units (204a and 204b).
S312 (Processing Step)

In this processing step, processing for starting up (starting) the timer of the digital camera is performed. This processing is performed to start up the timer in the control unit 201 in order to measure the elapse of a prescribed period of time. Note that, when the timer has started up (is operating), if orientation change and/or acceleration is detected again (YES in step S309) and step S312 is performed, the timer is reset to the initial value once, and is again started up. Accordingly, if the position and/or orientation of the digital camera is not changed for a certain period of time since the STBC transfer setting is performed due to detection of orientation change and/or acceleration, the STBC transfer setting is cancelled.
S313 (Processing Step)

In this processing step, calibration for wireless communication under the MIMO transmission method is performed. The calibration processing is performed so as to calculate a parameter for forming a plurality of streams under the MIMO transmission method. A procedure used at this time is performed in accordance with a prescribed procedure specified in IEEE 802.11n.
S314 (Processing step)

In this processing step, a wireless transmission path not under the STBC transmission method, but under only the MIMO transmission method is set. In accordance with the result in the processing step S313, wireless communication is performed under the MIMO transmission method when the image data is transmitted from the digital camera to the server device. However, in this step, processing for forming wireless transmission is performed without performing the STBC transmission method setting.
S315 (Processing Step)

In this processing step, the timer is reset to the initial value. At this time, the timer provided in the control unit 201 is reset to the initial value (reset state, e.g., 0), and the timer itself is not started up (not operating).
S316 (Processing Step)

In this processing step, the image data is transferred from the digital camera to the server device. Using the wireless transmission path for the transmission method that was set in the processing step (either S306, S311 or S314), processing to transfer the image data is performed.
S317 (Condition Determination Step)

In this condition determination step, path selection is performed based on the condition of whether or not the end of the processing to transfer the image data from the digital camera to the server device is detected. If the operator operates so as to end the image data transfer, or if the entire scheduled image data transfer is finished (YES in step S317), processing proceeds to a processing step S318. If not (NO in step S317), processing proceeds to the condition determination step S308. The aforementioned operation to end the transfer by the operator is determined by detection of the pressing of the prescribed button or the like by the operation input unit 205 of the digital camera.
S318 (Processing Step)

In this processing step, the image data transfer from the digital camera to the server device is finished. Disconnection of the wireless transmission path formed between the digital camera and the server device is performed in accordance with a procedure specified in a prescribed standard (standard related to IEEE 802.11 etc.).
S319 (Processing Step)

In this processing step, the timer is reset to the initial value. At this time, the timer provided in the control unit 201 is reset to the initial value (reset state, e.g., 0), and the timer itself is not started up (not operating).
S320 (Terminal Step)

This terminal step indicates the end of the flow chart. This state is a stand-by state of the digital camera.

As described above, the digital camera (STA 10) as a communication apparatus according to the present exemplary embodiment can perform wireless communication with an external apparatus by switching between a first communication method in which the transmission rate is given priority and a second communication method in which communication reliability is given priority. Also, a change in the position and/or orientation of the digital camera is detected. When a change in the position and/or orientation of the digital camera is detected during communication using the first communication method, switching processing for switching the communication method for use from the first communication method to the second communication method is performed. Thus, according to the present exemplary embodiment, in accordance with a change in the position and/or orientation of the digital camera, the communication method can be switched appropriately.

Here, in the present exemplary embodiment, the MIMO communication in which the STBC transmission method is applied is used as the second communication method, and the MIMO communication in which the STBC transmission method is not applied is used as the first communication method. However, the communication method is not limited to these.

Also, in the present exemplary embodiment, during communication using the second communication method, if a change in the position and/or orientation of the digital camera is not detected for a predetermined period of time, the communication method for use is switched from the second communication method to the first communication method. Thus, assuming it to be the case that the position and/or orientation of the digital camera is not changed, and if the communication environment is stable, the communication method is automatically switched to the first communication method, enabling fast data transfer.

In the present exemplary embodiment, in addition to the configuration described in the first exemplary embodiment, a configuration that switches to communication in which the STBC transmission method is applied is described. Communication is switched if the intensity of a received signal received from an external apparatus that is a communication partner reaches a predetermined value or less during communication in which the STBC transmission method is not applied.

Transmission Control

FIG. 4 is a flow chart showing the processing performed by the digital camera (STA 10) when the digital camera starts up within a wireless area of the server device (AP 20). The flow chart shows the case in which wireless transmission is set so as to be performed in high-reliability transfer mode when image data is transmitted from the digital camera to the server device (AP 20). Hereinafter, the steps of such processing will be described.
S401 (Terminal Step)

This terminal step shows the start of the flow chart. This state indicates that the power of the digital camera is OFF, and corresponds to a state before association processing between the digital camera and the server device is performed.
S402 (Condition Determination Step)

In this condition determination step, path selection is performed based on the condition of whether or not the power of the digital camera is turned ON. If the power of the digital camera is turned ON (YES in step S402), processing proceeds to a condition determination step S403. If not (NO in step S402), the present state is maintained.
S403 (Condition Determination Step)

In this condition determination step, path selection is performed based on the condition of whether or not an operation to start processing for the transmission of the image data from the digital camera to the server device has been performed. If processing for transmitting the image data starts due to an operation by the operator (YES in step S403), processing proceeds to a processing step S404. If not (NO in step S403), the present state is maintained.
S404 (Processing Step)

In this processing step, a procedure is performed so that the digital camera can perform wireless connection to the server device. Such processing is performed in accordance with a prescribed procedure specified in a standard related to IEEE 802.11 or a prescribed procedure specified in another communication protocol. Specifically, association request/response frames are exchanged, and parameter exchange and the like are performed.
S405 (Processing Step)

In this processing step, calibration is performed for wireless communication under the MIMO transmission method. The calibration processing is performed so as to calculate a parameter used when a plurality of streams are formed under the MINO transmission method. A procedure used at this time is performed in accordance with a prescribed procedure specified in IEEE 802.11n.
S406 (Processing Step)

In this processing step, a wireless transmission path is set under the STBC transmission method and the MIMO transmission method. In accordance with the result in the processing step S405, when the image data is transmitted from the digital camera to the server device, setting processing for performing wireless communication under the MIMO transmission method is performed, and also setting processing for performing wireless communication under the STBC transmission method is performed.

In order to perform wireless communication under the STBC transmission method, in the encoding/decoding processing unit 203, after a plurality of streams are generated, data −s1*, s0* (* is a complex conjugate) is generated from the streams (s0, s1). Then, time-division is performed so as to transmit the data s0, s1 and −s1*, s0*, for example, at times t and t+T to the antenna weight processing units (204a and 204b).

Also, the timer provided in the control unit 201 is set to an initial value (reset state), and the timer itself is not started up (not operating). Note that, the timer is also used for measuring elapsed time from when communication starts using the STBC transmission method between the digital camera and the server device.
S407 (Condition Determination Step)

In this condition determination step, path selection is performed based on the condition of whether or not an operation to start transferring the image data from the digital camera to the server device has been performed. When the operator performs an operation so as to start transferring the image data, the operation input unit 205 detects this operation and notifies the control unit 201 of the operation. If the control unit 201 receives the notification (YES in step S407), processing proceeds to a condition determination step S408. If not (NO in step S407), the present state is maintained.
S408 (Condition Determination Step)

In this condition determination step, path selection is performed based on the condition of whether or not the timer provided in the control unit 201 indicates a prescribed value or less. If the timer indicates the initial value (reset state), or the prescribed value or less (YES in step S408), processing proceeds to a condition determination step S409. If not (NO in step S408), processing proceeds to a processing step S413.
S409 (Condition Determination Step)

In this condition determination step, path selection is performed based on the condition of whether or not the position and/or orientation of the digital camera has been changed due to orientation change (the device being moved) and the like. Specifically, when the tilt detection unit 206 detects the orientation of the digital camera being changed through certain angles, and/or the digital camera being moved with a certain acceleration, the position and/or orientation of the digital camera is determined to have been changed. It it is determined that the position and/or orientation has been changed (YES in step S409), processing proceeds to a condition determination step S410. If not (NO in step S409), processing proceeds to a processing step S417.
S410 (Condition Determination Step)

In this condition determination step, path selection is performed based on the condition of whether or not the STBC transmission method is used for the wireless transmission path between the digital camera and the server device. If the wireless transmission path has been formed for the STBC transmission method (YES in step S410), processing proceeds to a processing step S412. If not (NO in step S410), processing proceeds to a processing step S411.
S411 (Processing Step)

In this processing step, a wireless transmission path under the STBC transmission method is set between the digital camera and the server device. In order to perform wireless communication under the STBC transmission method, in the encoding/decoding processing unit 203, after a plurality of streams is generated, data −s1*, s0* (* is a complex conjugate) is generated from the streams (s0, s1). Then, time-division is performed so as to transmit the data s0, s1 and −s1*, s0*, for example, at times t and t+T to the antenna weight processing units (204a and 204b).
S412 (Processing Step)

In this processing step, processing for starting up (starting) the timer of the digital camera is performed. The processing is performed to start up the timer in the control unit 201 in order to measure the elapse of the prescribed period of time. Note that, similar to the first exemplary embodiment, when the timer has started up (is operating), if orientation change and/or acceleration is detected again (YES in step S409) and step S412 is performed, the timer is reset to the initial value once, and is again started up.
S413 (Condition Determination Step)

In this condition determination step, path selection is performed based on the condition of whether or not the intensity of a received signal is lower than the prescribed value. Due to an instruction from the control unit 201, the antenna weight processing units 204a and 204b notify the control unit 201 of the detection result for the intensity of the received signals received by the antennas. If the detection result is smaller than the prescribed value (YES in step S413), processing proceeds to the condition determination step S409. If not (NO in step S413), processing proceeds to a processing step S414.
S414 (Processing Step)

In this processing step, calibration for wireless communication under the MIMO transmission method is performed. The calibration processing is performed so as to calculate a parameter for forming a plurality of streams under the MIMO transmission method. A procedure used at this time is performed in accordance with a prescribed procedure specified in IEEE 802.11n.
S415 (Processing Step)

In this processing step, a wireless transmission path not under the STBC transmission method, but under only the MIMO transmission method is set. In accordance with the result in the processing step S414, wireless communication is performed under the MIMO transmission method when the image data is transmitted from the digital camera to the server device. However, at this moment, processing for forming a wireless transmission path is performed without performing the STBC transmission method setting.
S416 (Processing Step)

In this processing step, the timer is reset to the initial value. At this time, the timer provided in the control unit 201 is reset to the initial value (reset state, e.g., 0), and the timer itself is not started up (not operating).
S417 (Processing Step)

In this processing step, the image data is transferred from the digital camera to the server device. Using the wireless transmission path under the transmission method that was set in the processing step (S406, S411 or S415), processing to transfer the image data is performed.
S418 (Condition Determination Step)

In this condition determination step, path selection is performed based on the condition of whether or not the end of the processing to transfer the image data from the digital camera to the server device is detected. If the operator operates so as to end the image data transfer, or if the entire scheduled image data transfer is finished (YES in step S418), processing proceeds to a processing step S419. If not (NO in step S418), processing proceeds to the condition determination step S408. The aforementioned operation to end transfer by the operator is determined by detection of the pressing of the prescribed button or the like of the operation input unit 205.
S419 (Processing Step)

In this processing step, the image data transfer from the digital camera to the server device is finished. Disconnection of the wireless transmission path formed between the digital camera and the server device is performed in accordance with a procedure specified in a prescribed standard (standard related to IEEE 802.11 etc.).
S420 (Processing Step)

In this processing step, the timer is reset to the initial value. At this time, the timer provided in the control unit 201 is reset to the initial value (reset state, e.g., 0), and the timer itself is not started up (not operating).
S421 (Terminal Step)

This terminal step indicates the end of the flow chart. This state is a stand-by state of the digital camera.

As described above, in the present exemplary embodiment, the digital camera determines the intensity of a received signal from the external apparatus. Also, if the intensity of a received signal received from an external apparatus that is a communication partner is lower than or equal to the predetermined value during communication using the first communication method, the communication method for use is switched from the first communication method to the second communication method. Thus, with the configuration according to the present exemplary embodiment, if the radio wave intensity deteriorates, the communication method is automatically switched to a communication method in which reliability is given priority. Thus, high-quality communication can be continued.

It goes without saying that the present invention can also be embodied by executing a software program code that realizes the functions described in the aforementioned exemplary embodiments in a system or an apparatus. In this case, the program code itself realizes the functions described in the aforementioned exemplary embodiments. Thus, the program code is included in the technical scope of the present invention.

The program code can be supplied to a system or an apparatus, being recorded, for example, on a computer-readable recording medium. A computer (or CPU or MPU) in the system or the apparatus reads and executes the program code stored in the recording medium. The present invention can also be achieved thereby. Accordingly, the recording medium having the program code stored thereon is also included in the technical scope of the present invention.

Examples of the recording medium for providing the program code include a flexible disk, a hard disk, an optical disk, a magneto-optical disk, a CD-ROM, a CD-R, magnetic tape, a non-volatile memory card, a ROM, a DVD and the like.

Note that, the program code is not limited to program code that includes all elements used for realizing the functions described in the aforementioned exemplary embodiments by the computer reading and executing the program code. That is, the program code also includes a program code that achieves the object by cooperating with at least either software or hardware installed on the computer.

For example, based on an instruction included in the program code, an OS or the like operating on the computer performs all or part of the actual processing. Thus, the processing realizes the functions described in the aforementioned exemplary embodiments. In such a case, the program code is also included in the technical scope of the present invention. Note that, the OS is an abbreviation for operating system.

Or, for example, based on an instruction included in the program code, a CPU or the like included in a function expansion board or a function expansion unit that is inserted in or connected to the computer performs all or part of the actual processing. Then, the functions described in the aforementioned embodiments may be realized through that processing. In such a case, the program code is included in the technical scope of the present invention. Note that, the function expansion board or the function expansion unit can perform such processing by reading the program code into the memory included therein and executing the program code.

As described above, with the configuration according to the aforementioned exemplary embodiment, in accordance with a change in “the state of the transmission path” under the MIMO transmission method, the transmission method can be switched to a high-reliability transmission method when the orientation of the apparatus itself is changed, the apparatus is moved or the like. Consequently, deterioration of “the state of the transmission path” can be predicted. Also, transmission data can be prevented from being wastefully transmitted. Thereby, decrease in throughput due to re-transmission, loss of transmission data due to transfer error or the like can be prevented.

Also, even when the method is changed to the high-reliability transmission method once, and data transfer is performed, if a prescribed condition regarding a wireless transmission path is satisfied since the orientation of the apparatus itself was not changed or the apparatus was not moved for a certain period of time, the method can be automatically changed to a fast transmission method. Consequently, even after the method is changed to a high-reliability transmission method due to deterioration of “the state of the transmission path”, the method can be switched to the fast transmission method in accordance with “the state of the transmission path”. Thus, throughput can be adaptively increased.

Note that, when the orientation of the apparatus itself is changed or the apparatus is moved, a transmission method in which reliability is given priority may be switched to a transmission method in which the transmission rate is given priority.

As described above, the communication apparatus of the present invention switches the transmission method in accordance with the orientation of the apparatus being changed, the apparatus being moved or the like. Note that, the transmission method is not limited to the STBC and non-STBC methods that are described in the aforementioned exemplary embodiments, and examples of the transmission method may also include wireless LAN (IEEE 802.11 series), Bluetooth, IrDA (Infrared Data Association), WUSB (Wireless USB), Wireless-HD (High Definition) and the like.

Also, when switching the above transmission methods, for example, a transmission method in which the error rate is low may be switched to/from a transmission method in which the transmission rate is given priority. Also, a transmission method in which the communication range is large may be switched to/from a transmission method in which the communication range is small. Also, a wired transmission method may be switched to/from a wireless transmission method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-119056, filed Apr. 30, 2008, which is hereby incorporated by reference herein in its entirety.

What is claimed is:

1. A communication apparatus that can perform communication with an external apparatus by switching between a plurality of communication methods, the communication apparatus comprising:
a detection unit that detects a change in a position and/or orientation of the communication apparatus; and
a switching unit that switches a communication method for use in accordance with a detection result by the detection unit.

2. The communication apparatus according to claim 1, further comprising:
a determination unit that determines the intensity of a received signal from the external apparatus,
wherein the switching unit switches the communication method for use if the intensity determined by the determination unit is a predetermined value or less.

3. The communication apparatus according to claim 1,
wherein the plurality of communication methods include a method in which a space-time block coding method is applied and a method in which the space-time block coding is not applied.

4. The communication apparatus according to claim 1,
wherein if the detection unit detects the change in the position and/or orientation of the communication apparatus during communication using a first communication method in which a transmission rate is given priority, the switching unit switches the communication method for use from the first communication method to a second communication method in which communication reliability is given priority.

5. The communication apparatus according to claim 4,
wherein if the detection unit does not detect a change in the position and/or orientation of the communication apparatus for a predetermined period of time during communication using the second communication method, the switching unit switches the communication method for use from the second communication method to the first communication method.

6. A method for controlling a communication apparatus that can perform communication with an external apparatus by switching a plurality of communication methods, the method comprising the steps of:
detecting a change in a position and/or orientation of the communication apparatus; and
switching a communication method for use in accordance with a detection result in the detecting step.

7. The method for controlling the communication apparatus according to claim 6, further comprising the step of determining the intensity of a received signal from the external apparatus,
wherein the communication method for use is switched in the switching step if the intensity determined in the determining step is less than or equal to a predetermined value.

8. The method for controlling the communication apparatus according to claim 6,
wherein the plurality of communication methods include a space-time block coding method and a non-space-time block coding method.

9. The method for controlling the communication apparatus according to claim 6,
wherein if a change in the position and/or orientation of the communication apparatus is detected in the detecting step during communication using a first communication method in which transmission rate is given priority, the communication method for use is switched in the switching step from the first communication method to a second communication method in which communication reliability is given priority.

10. The method for controlling the communication apparatus according to claim 9,
wherein if a change in the position and/or orientation of the communication apparatus is not detected in the detecting step for a predetermined period of time during communication using the second communication method, the communication method for use is switched form the second communication method to the first communication method.

11. A computer-readable storage medium having recorded thereon a program for causing a computer to function as the communication apparatus according to claim 1.
